(19) United States
(12) Patent Application Publication
(10) Pub. No.: US 2024/0022492 A1
(43) Pub. Date: Jan. 18, 2024

(54) Top KPI Early Warning System

(71) Applicant: Parallel Wireless, Inc., Nashua, NH (US)

(72) Inventor: Nihar Nanda, Acton, MA (US)

(21) Appl. No.: 18/351,491

(22) Filed: Jul. 12, 2023

Related U.S. Application Data
(60) Provisional application No. 63/388,397, filed on Jul. 12, 2022.

(51) Int. Cl. H04L 43/091; H04L 41/16

(52) U.S. Cl. CPC H04L 43/091; H04L 41/16

(57) ABSTRACT

A method of providing warnings in a telecom network based on forecasting Key Performance Indicators (KPIs), the method comprising: receiving, at a data processing and preparation service, data; transforming, by the data processing and preparation service, the data and feeding transformed data to a forecasting model; predicting, by the forecasting model, a future KPI value for each cell, wherein each KPI has a pre-trained model for prediction that covers all cells; sending, by the forecasting model, predictions to a notification component; receiving, by the notification component, predicted KPI values; and matching, by the notification component, the predicted KPI value against a threshold to generate warnings for any predicted value that exceeds the threshold.

### CROSS-REFERENCE TO RELATED APPLICATIONS

The present application claims the benefit of priority under 35 U.S.C. § 119(e) to U.S. Provisional Patent Application No. 63/388,397, having the same title as the present application and filed Jul. 12, 2022, hereby incorporated by reference in its entirety for all purposes. In addition, the present application hereby incorporates by reference, for all purposes, each of the following U.S. patent Application Publications in their entirety: US20190243836A1; US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This document also hereby incorporates by reference U.S. patent application Ser. No. 18/174,580 in its entirety. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1 in their entirety.

### BACKGROUND

Cellular networks are complex—devices distributed over large geographies, connected by many protocols, operated by multiple operators and standards delivering services to mobile devices. Consumers expect the networks to be omni-present, available, performing at the fullest capacity without any failure. Each country has regulatory bodies who prepare regulations, audit telecom operators, control services available to consumers. Operators are always under strict supervision to maintain top levels of service due to fierce competition and regulatory pressure.

Cellular technology continuously evolves to catch up with the demand generated by smart phone apps, IoT, population, connected devices, RAT generation changes. Operators are continuously challenged maintaining network operations at highest levels of efficiencies and availability keeping customers happy. Network performance measurement is a fundamental mechanism for operators, regulators, vendors, and customers to understand operational characteristics. Standard bodies in telecom industry define a set of KPIs for coverage, capacity, availability, fault, congestion, etc., used to compare contrast operational efficiencies from various parts of network, vendor devices, upgrades, or replacements.

In a separate area of knowledge, a machine learning model is a program that is used to make predictions for a given data set. A machine learning model is built by a supervised machine learning algorithm and uses computational methods to “learn” information directly from data without relying on a predetermined equation. More specifically, the algorithm takes a known set of input data and known responses to the data (output) and trains the machine learning model to generate reasonable predictions for the response to new data.

### SUMMARY

Forecasting has been in use by many industries for decades providing useful information how to run business reducing catastrophe. Autoregressive statistical regression techniques were at the forefront for many years until researchers used Deep Learning models for forecasting. Retail, supply-chains widely used forecasting models to predict demand in-advance so inventory levels can be closely maintained without buildup.

Statistical models are simple, use less compute resource compared to deep learning models and easy to setup for many use cases. Depending on historical data and patterns accuracy of statistical predictive models varies to a large degree. Our approach is to explore both statistical and deep learning models choose which technique provide better results predicting KPIs.

In one embodiment, a method is disclosed of providing warnings in a telecom network based on forecasting Key Performance Indicators (KPIs), the method comprising: receiving, at a data processing and preparation service, data; transforming, by the data processing and preparation service, the data and feeding transformed data to a forecasting model; predicting, by the forecasting model, a future KPI value for each cell, wherein each KPI has a pre-trained model for prediction that covers all cells; sending, by the forecasting model, predictions to a notification component; receiving, by the notification component, predicted KPI values; and matching, by the notification component, the predicted KPI value against a threshold to generate warnings for any predicted value that exceeds the threshold.

The method may further comprise training a plurality of forecasting models, one per KPI. The method may further comprise training the plurality of forecasting models at a non-real time radio access network intelligent controller (non-RT RIC) in an OpenRAN compatible deployment architecture. The method may further comprise performing the method for multiple KPIs. The method may further comprise training the plurality of forecasting models to be specific to individual cells. The method may further comprise training the plurality of forecasting models for individual cells at a near-real time radio access network intelligent controller (near-RT RIC). The KPIs may be 4G or 5G networking metrics. The KPIs may be 2G or 3G networking metrics. The plurality of forecasting models may be one of convolutional neural networks (CNNs) or long short term memory networks (LSTMs). The at least one N-dimensional tensor may be used for training N-dimensional models which can provide context for context-aware predictions.

### BRIEF DESCRIPTION OF THE DRAWINGS

FIG. 1 shows a solution architecture, in accordance with some embodiments.

FIG. 2 shows a data flow, in accordance with some embodiments.

FIG. 3 depicts a diagram of the data stores in the solution architecture, in accordance with some embodiments.

FIG. 4 is a schematic diagram of a data pipeline, in accordance with some embodiments.

FIG. 5 is a schematic diagram of a multi-RAT RAN deployment architecture, in accordance with some embodiments.

FIG. 6 is a further schematic diagram of a multi-RAT RAN deployment architecture, in accordance with some embodiments.

### DETAILED DESCRIPTION

Performance KPI measurement and monitoring is a continuous process where each operating device independently generate network measurements which is collected centrally, processed, generates KPIs. Operators, Regulators, Vendors, Senior and executive management use performance KPIs as a standard tool for negotiating vendor contracts, compare operations, improve network topology, operation targets, regulations, etc.

At NOCs (Network Operating Centers) operated by network operators, performance KPIs are observed continuously to run networks at the highest efficiencies detecting and avoiding service degradation and equipment failures. As any failure points detected, service technicians are dispatched to restore from software or hardware failures. Technicians performing these duties are constantly under pressure to diagnose the root cause and restore service.

Typically, technicians are dispatched after the failure, e.g., failure mitigation is operationally reactive: Monitoring KPIs identify faults only after an event happens.

However, recently-developed Deep Learning ML algorithms have abilities to forecast KPIs slightly ahead of time with a high degree of accuracy. Knowing future direction and quantity of change in a measured KPI changes network operational paradigm. Using forecasts the operator has enhanced reactionary time window to act. In some cases, the actions may prevent potential catastrophe from happening. Predictive forecasting is therefore a game changer that transforms traditional reactive to preventative.

Objective

Top KPI Early Warning System (KEWS) is an ML application generates performance degradation alert ahead of time (in some embodiments on the order of 15-30 mins) with high degree of accuracy. The system allows operator to set thresholds for each KPI; any predicted value failing below generates a warning or an alert. Network support engineers might prevent the disaster from happening or prepare plans restoring service otherwise.

In a KEWS (Top KPI Early warning system) for Cellular Networks, as described herein, operators choose which KPIs to forecast. As described herein, the forecasted KPIs may include one or more of the following as well as any other well-understood KPIs. For example, General RF operational KPIs include: One-way-latency; Jitter; Availability; Reliability; General data operational KPIs include: Packet Loss; Connection Density; Area Traffic; Capacity; User Experienced Data Rate; Guaranteed Data Rate; Data Volume; Signal KPIs include; SS-RSRP; CSI-RSRP; SS-RSRO; CSI-RSRQ; SS-SINR; CSI-SINR; General component operational KPIs include: Component Onboarding and Configuration time; Component Deployment Time; Slice Creation/adaption Time in 5G; Time to Scale; Component uptime. Additionally, some user-side operational scenarios you can test using KPIs include: Youtube streaming; Web navigation; Third party network measurement apps usage; File download; Video streaming; File upload; Ping; Traceroute; Social media; etc.

In some embodiments, the operator sets thresholds for each top KPIs that, when hit, generate alarm/warning. Then, ML Forecasting models predict KPI value ahead of time. For example, when device measurement data is made available to forecaster at time t, models predict value of KPIs at time t+Δt.

If forecasted KPI value falls below threshold, an early warning message generated and pushed to responsible individuals. Operation personnel determine either to act upon the warning or ignore. Benefits include that network operators have generation of warning/alert allow extra time for service support engineers that, if acted upon, can prevent bad situation from happening, or allows additional preparation time to deal with failures that are unavoidable.

As well, deployments require managed support for a period. Our field organizations monitor customer site performance continuously report KPIs as per contract, troubleshoot problems. An early warning system should help field engineers either prevent or get ready handle failure situations. This can become a tool for managed solution to customers, or even be useful for improving system design.

For example: we receive an early warning where call drop rates will go beyond threshold in next 15-30 mins. What can support engineers do to prevent or manage situation? Choices are—analyze how busy the cell is, if it is, divert traffic to neighboring cells, or review cell resource consumption to identify abnormalities, or enable verbose log collection for an in-depth analysis at a later stage, or do nothing. Actions mentioned are root-cause situations which varied by customer, engineer on-site, maturity of the software, operating conditions.

In sum, Maintaining network and running at highest throughput is hard. Any action that either prevents component failure or enables support staff to prepare for evitable conditions, is tremendous. An effective troubleshooting and mitigation competency requires an early warning system to be in place so that engineers regularly perform root-cause analysis, provide deep understanding of actions when to take, leading a path towards automation. Building an automated root-cause analysis and preventative care is a journey which begins with the ability to generate early warnings.

Solution Approach

Forecasting of KPI values should maintain a high degree of accuracy. Practitioner will have faith in early-warning only when forecasting accuracies are high and predictability are consistent. Bad warnings adversely impact solution dependability. General principles that drive this solution are: Prediction accuracies should be high and consistent; Predictive model maintains published accuracy levels over the period of use; Model should explain predictions logically; and historical data needed for training should be low, if possible.

Analysis of Solution Methodology

Forecasting has been in use by many industries for decades providing useful information how to run business reducing catastrophe. Autoregressive statistical regression techniques were at the forefront for many years until researchers used Deep Learning models for forecasting. Retail, supply-chains widely used forecasting models to predict demand in-advance so inventory levels can be closely maintained without buildup.

Statistical models are simple, use less compute resource compared to deep learning models and easy to setup for many use cases. Depending on historical data and patterns accuracy of statistical predictive models varies to a large degree. Our approach is to explore both statistical and deep learning models choose which technique provide better results predicting KPIs.

Research indicates Deep Learning models have significant advantages over the statistical models forecasting network KPIs. These data sets are highly cyclical over a small time periods such as hours, changes with weekdays, and non-time bound parameters such as weather, events, geological phenomenon, etc.

Solution Architecture

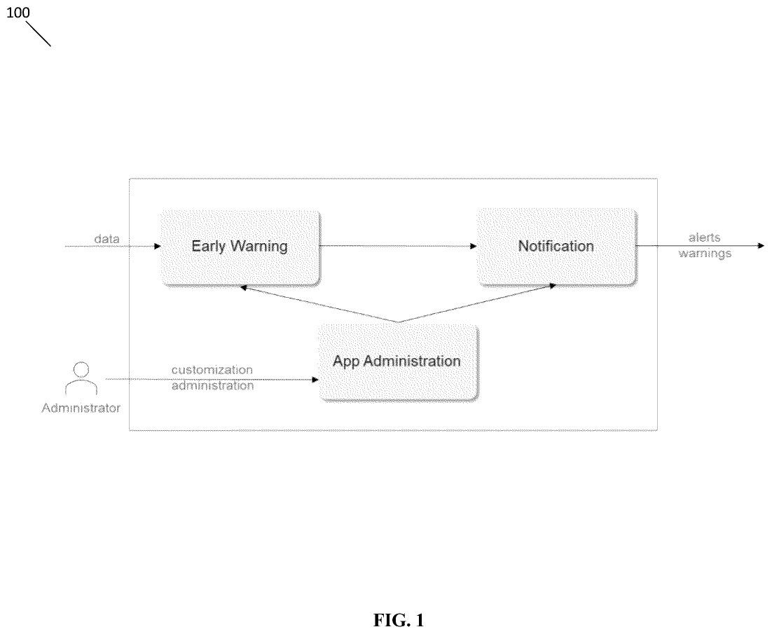

FIG. 1 shows a solution architecture, in accordance with some embodiments. KEWS (Top KPI Early warning system) has three main components: 1. App administration, 2. Early Warning, and 3. Notification. Three components make the application provide customized early warnings to the customer organization. FIG. 1 describes major components of this system.

App Administrator

An app administrator uses this component configure, customize early-warning app running in their environment. Customization choices should include, KPIs and formulas, list of base stations included in the early-warning system, selection of RAT for base stations, KPI thresholds for alerts and warnings, delivery and distributions lists for alerts and warnings. Few read only screens should be part of the application administration present model performance measurements and explanation on decisions.

Early Warning

Early Warning is core application component which includes the forecasting model. A data processing and preparation service receives data and transforms to feed into the forecasting model as input. The forecasting model predicts future KPI value for each cell and sends to Notification component. Each KPI has a pre-trained model for prediction that covers all cells.

An observer service running offline estimates prediction accuracies of trained models determine when model re-training will be required.

Notification

Notification component receives predicted KPI values, matches against customer set thresholds to generate warnings. Any predicted value exceeding customer set thresholds generate warning messages send to pre-determined list of service engineers in preferred channels as defined by the Administrator earlier. The warning message content may include cell ID, prediction accuracy, etc.

As the system evolves, warning message may include possible root cause scenarios and/or recommended actions to be considered by the service engineers.

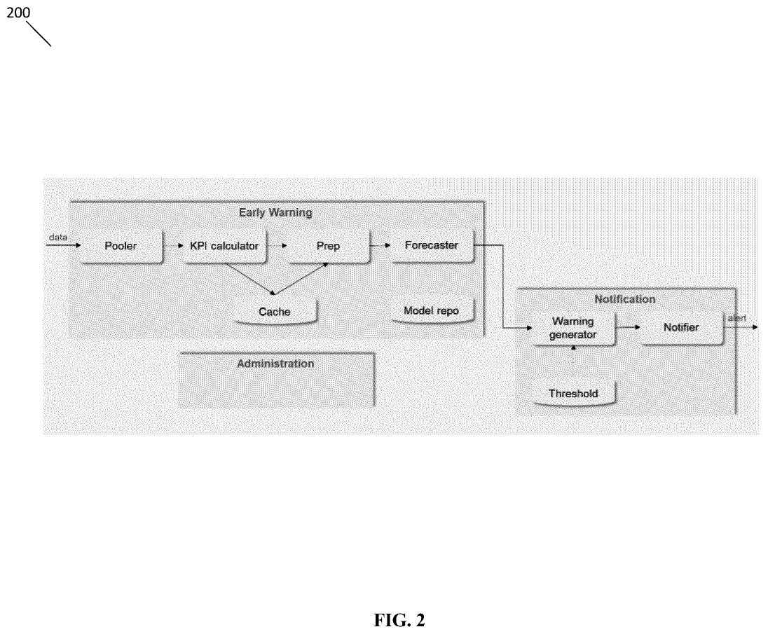

FIG. 2 shows a data flow, in accordance with some embodiments.

Typically, KPI data is stored in a network operator's data store in a relational database. The KPIs are stored in records that include information such as: timestamp, associated info such as UE, prepaid account, cell, tracking area, etc. In some embodiments, raw KPI data is transformed into an N-dimensional tensor that is suitable for use for training ML models, including N-dimensional models which can provide context for context-aware predictions. In some cases KPIs need to first be calculated from underlying cell counter data, such as calculation the number of call drops during a given time period based on individual records of call drops, for example. Then, by transforming such KPI data into an N-dimensional tensor, context-aware ML processing is facilitated. Additionally, multiple types of context can be accommodated, in particular, the context of a single cell, but additionally including, for example, the context of a single UE, or a particular time of day or network condition, or a combination of multiples of these contexts. In some embodiments, a single model can be prepared and trained that takes into account these multiple contexts, and, the model can be queried for context-specific recommendations.

In FIG. 2, flow 200 shows a data flow. KPIs are calculated from the counter data which is collected from every cell in the network periodically, processed and stored in the database in the management system. KEWS system can access counter data for each cell from management/SON tables periodically. A pull mechanism from KEWS scans table inserts triggering new data selection. The input data should contain counters required for KPI calculations.

Early warning component polls counter data changes from management/SON tables periodically for each cell configured by the administrator. Then, using KPI formula and counter values for each cell, the KPI calculator calculates the value and pass it to the KPI model data preprocessor. Inference engine loads the corresponding KPI model to forecast. This step is repeated for cells in the list. The following pseudocode provides an algorithm therefor.

```
If new_data=True in watched_tables: then
  For cell in all_cells loop:
    Fetch counter_data for cell
    For KPI in list of KPIs loop:
      KPI_i_cell = (Calculate KPI from underlying cell counter
values using KPI formula)
      Cell_kpi_list_current = Store in 2d-list as cell and KPI
values
  For cell in all cells loop:
    Cell_KPO_model_tensor = transformation function
      Cell_kpi_model_tensor = transformed data
```

Various alternative algorithms are also considered, for example, looping over different subsets of cells, different orders of operating on cells, creating a tensor that includes data from multiple cells or a grouping of cells such as a group of cells managed by a single management function or a single near-RT RIC in 5G networking, or a single tensor that includes data from all cells, or looping on UEs instead of cells, or looping on tracking areas instead, etc.

Various types of models can be used, in some embodiments. For example, various types of deep learning models, e.g., Convolutional Neural Networks (CNNs), Long Short Term Memory Networks (LSTMs), Recurrent Neural Networks (RNNs), Generative Adversarial Networks (GANs), Radial Basis Function Networks (RBFNs), Multilayer Perceptrons (MLPs), Self Organizing Maps (SOMs), or other types of non-deep learning models could be used. The depth of the deep learning models could be configured differently based on the available amount of computation, the desired operation speed, the desired training speed, etc. The models can be configured based on the network latency such that the granularity of changes that are monitored by the KPI early warning network correspond to changes that can be performed in real time to mitigate warning scenarios, and that the granularity does not exceed a latency appropriate for the network. For example, in LTE the network typically can respond no faster than every 1 ms to any network change. A regression model may be used as we are predicting continuous KPIs; however, this may be used with a classifier model in the case that an operator desires to use this architecture with metrics that are discrete classifiers.

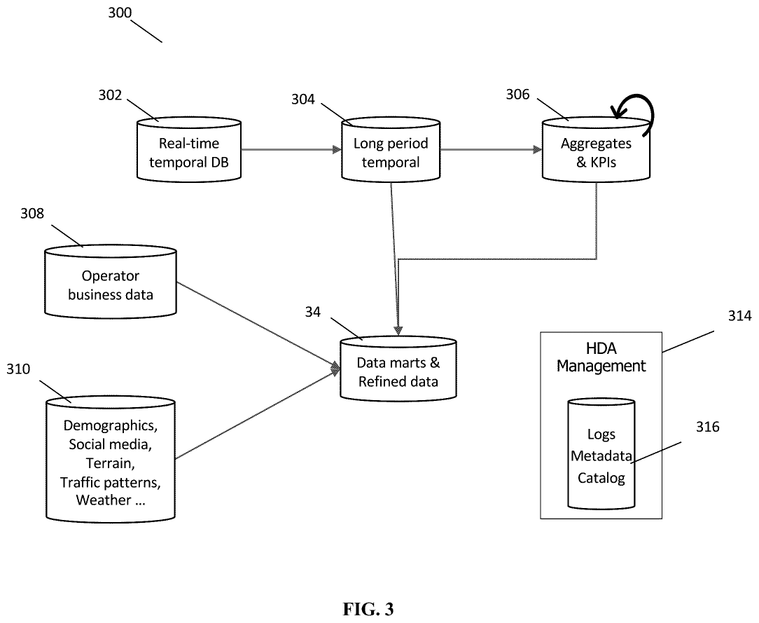

Referring now to FIG. 3, an HDA data store 300 is shown in accordance with some embodiments. The HDA data store 300 includes a real-time temporal database 302 which is used for operational dashboard. The real-time temporal database 302 is in communication with a long period temporal database 304. The long term temporal database 304 provides long term storage (e.g. two years or more) for counters, UE aggregates and derived data sets. The HDA data store 300 also includes an aggregates and KPIs database 306. This database 306 is in communication with the long period temporal database 304, and is used for statistical processes, classification, regression and aggregation of data.

Also shown is an operator business data database 308, used for storing operator specific internal data ingested into the HDA data lake. A demographics, social media, terrain, traffic patterns and weather database 310 may be included in the HDA and is used to store data from public data sources ingested into the HDA for building models. A data marts and refined data database 312 is used to store ML, AI or statistical models generating refined data sets for use. Database 312 is in communication with database 304, 306, 308 and 310.

The HDA management data store 314 includes a logs, metadata and catalog database 316. The database 316 store HDA management data including security data, metadata, auditable access logs and a data catalog.

The HDA store provides information persistence, information management services and information distribution services. The information persistence service ensures incoming or derived data sets are stored in most efficient format based on intended usage pattern. For example, a real-time data set used in operational dashboard is stored in a time-series database to optimize the ingest rate while facilitating the time-series windowing techniques for aggregation and analytics.

The information management service comprises a set of build-in management services ensuring data sets are securely accessed by the users or systems with audit trails. Data analysts can use the catalog feature to find datasets that can be used to build analytical models or analytics.

The information distribution service includes data sets stored in HDA that are made available for use by authorized users using data services. The data services range from direct JDBC/ODBC access to complex REST service protocols. A set of management services enables definition, configuration and deployment of secure data access.

The functional requirements of the data stores in the HDA include one or more of the following: ability to store time-series data sets for real-time and longer period aggregation and analytics; ability to ingest public or 3rd party aggregated data sets; ability to archive or migrate data from data stores based on time schedule or request; ability to store datasets in multiple formats such as: relational, columnar, text data; ability to capture and store metadata for ingested datasets; ability to generate user searchable catalog; ability to configure a logical data landing location associated security parameters; ability to encrypt data at rest; and ability to wrap secure Rest service to access datasets.

Analytic developers and consumers include network operators, business analysts, data scientists and external applications or servers. Network operators use real-time data and analytics dashboard tools to create personalized parameter measurements and thresholds for network monitoring and control. Network operators also report PIs and KPIs to management and use visual tools to build the dashboard and/or reports.

Business analysts use ad-hoc data analysis exploring historical trends, patterns, performance indicators, what-if analysis etc. The business analysts also use summarized historical data available from data marts and use desktop Business Intelligence tools or Excel performing analysis.

Data scientists build analytical models for ML, DL, Classification, Regression etc. Data usage depends upon the question to be answered. Prefer to use raw data for the models.

The data scientists also use statistical libraries written in Python, R etc. Programmers like to directly use the system.

The external applications or servers perform Apps or Micro services queries or download processed or refined data for closed loop or open loop processes or configurations or personalizing UE experience, etc. Additionally, the operationalization of analytics is used.

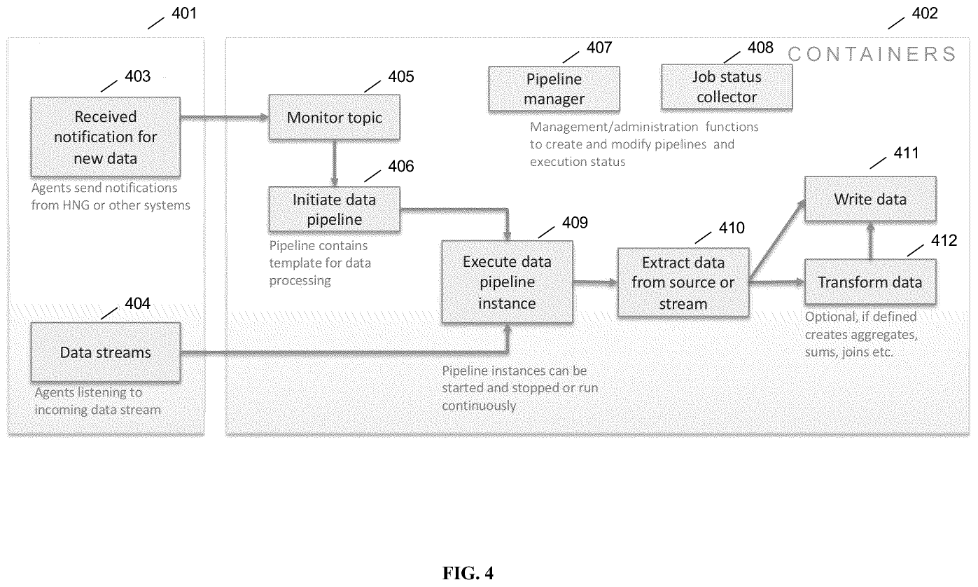

FIG. 4 depicts a simple flow for an exemplary micro-batch pipeline process flow takes place, in some embodiments of a data pipeline; other embodiments are considered as well. Data sources 401 are provided, with agents 403 and 404 located in different parts of the system. Processes 402 are containerized and located in the cloud infrastructure. Incoming data is made available periodically. When the data is made available, for example when a notification of new data is received at 403 or when incoming data arrives on an open data stream at 404, the processing elements comes to life and process the data. After processing completes the pipeline processes are turned off until next. The ingest system, which could use Kafka in some embodiments, in this case is used for two purposes, (1) to receive an event when data is available for processing and then (2) to host the data that needs to be processed. A simple client 405 connected to agent 403 monitors for the event in a topic indicating that a new set of data is available for processing.

Once that event is received, at step 406, a pipeline initiation process orchestrates a process event bringing the data processing pipeline to life. Once the data pipeline is active, at 409, it consumes data from the source, 410. At that point two parallel processes in pipeline are activated, one transforming the data, 412, to a desired format and the other, 411, writing the raw data to a disk location. The output of the transformation process finally writes the data back to a second designated location holding the process data.

During execution of this pipeline, processing statuses are from the logs by the offline processes marked as Pipeline Manager 407 and Job status collector 408 so that system administrators can see the processing status of the system and any errors. Each data pipelines deployed in the system has a versioning control to track the processing needs. New versions of can be deployed or retracted back to previous in case of errors.

Design advantages of this design include: pipeline supports parallel execution of tasks while the data is still present in the system memory; loosely coupled processes that defines a pipeline an be modified and enhanced without significant code change; new processing can be introduced within the pipeline without impacting the significant processing times; independent processing components can scale horizontally to reduce processing load; resources are used from the pools and returned back when done without blocks or reserves.

In some embodiments, a distributed data lake could be used. “Distributed Data Lake” is a design principle: in an Operators network a data lake can be instantiated at anywhere so that data processing can be done close to the collection point. It is expected that every data lake instance in the operators' network works collaboratively so that analytics user does not feel where the data processing is happening. All components that build data lake must be software, instantiated through orchestration, self-monitored for load. So, optimal platform size can be determined dynamically. Local data lake must be optimized to meet local data processing needs, data volume, data type and data verity. Data lake platforms should be designed to meet the sizing needs. Operators may choose to deploy multiple data lake at different locations with different footprints of data lakes as determined by the processing needs of the location. However, the analytics user should not see query processing bottlenecks while trying to access from various distributed data lakes. During installation of a data lake, the operator can choose from a list of optional services to use. Consider classifying data lake services as essential and optional. This applies to all software platforms such as Hadoop, Kaflka, Cassandra, Redis etc., available pipelines to bring data for storage. The installer during installation or after installation choose from the list of optional services to add to data lake. Compute, storage and network resources in the data lake are shared resources. Every process in data lake should be designed to release all possible unused resources back to the pool. While designing service footprints consider minimum amount of resources that will be required for operation. For example, a Kafka cluster requires a minimum of 3 instances to operate and during peak processing times it may require 5 instances. Kafka platform design should handle the cluster pool resource requirements.

In some embodiments, a cloud-scale adapter framework designed to bring data into base platform from external sources. The gateway layer consists of pre-build adapters designed to communicates with the telecom and wireless devices the adapter exposes data services to fetch data. Some devices can expose a control interface, or a control API for an analytics process to programmatically adjust settings. Cloud agents are gateways that enables data lake to access data from Internet services or customer databases and may be enabled to fetch data used for KPI computation, in some embodiments.

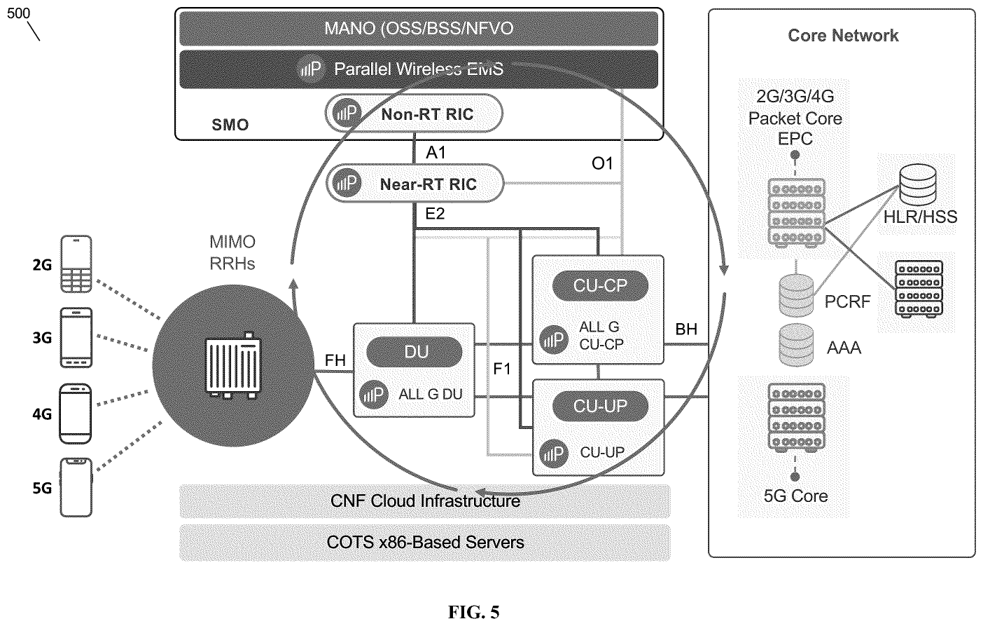

FIG. 5 is a schematic diagram of a multi-RAT RAN deployment architecture, in accordance with some embodiments. Multiple generations of UE are shown, connecting to RRHs that are coupled via fronthaul to an all-G Parallel Wireless DU. The all-G DU is capable of interoperating with an all-G CU-CP and an all-G CU-UP. CU function is split into CU-CP (Control Plane) and CU-UP (User Plane) function to provide Control and User Plane separation. Open RAN solution supports: Open Interfaces between different functions; Software based functions; Cloud Native functions; Intelligence support via support for xApps/rApps; 3rd Party RRHs; Disaggregated functions; White Box COTS hardware support; Data Path separated from Control plane traffic.

In some embodiments the present application may be located on the same physical device. In some embodiments, individual ML models may be deployed to the edge of the network, as shown by the arrow, in some embodiments to a near-RT RIC, or may be deployed at the non-RT RIC or at a centralized portion of the network. In some embodiments the application may be trained and/or deployed at a non-RT RIC. In some embodiments the model may be trained once and deployed to multiple near-RT RICs. The near-RT RIC may take input from various KPIs as described herein and may further cause actions to be taken. In some embodiments the operation of the application may be an xApp, an rApp, or both. The rApp may communicate with a corresponding xApp at the non-RT RIC, in some embodiments, and vice versa. The corresponding xApp may communicate with a management operation in the core network, in some embodiments.

Backhaul may connect to the operator core network, in some embodiments, which may include a 2G/3G/4G packet core, EPC, HLR/HSS, PCRF, AAA, etc., and/or a 5G core. In some embodiments an all-G near-RT RIC is coupled to the all-G DU and all-G CU-UP and all-G CU-CP. Unlike in the prior art, the near-RT RIC is capable of interoperating with not just 5G but also 2G/3G/4G.

The all-G near-RT RIC may perform processing and network adjustments that are appropriate given the RAT. For example, a 4G/5G near-RT RIC performs network adjustments that are intended to operate in the 100 ms latency window. However, for 2G or 3G, these windows may be extended. As well, the all-G near-RT RIC can perform configuration changes that takes into account different network conditions across multiple RATs. For example, if 4G is becoming crowded or if compute is becoming unavailable, admission control, load shedding, or UE RAT reselection may be performed to redirect 4G voice users to use 2G instead of 4G, thereby maintaining performance for users. As well, the non-RT RIC is also changed to be a near-RT RIC, such that the all-G non-RT RIC is capable of performing network adjustments and configuration changes for individual RATs or across RATs similar to the all-G near-RT RIC. In some embodiments, each RAT can be supported using processes, that may be deployed in threads, containers, virtual machines, etc., and that are dedicated to that specific RAT, and, multiple RATs may be supported by combining them on a single architecture or (physical or virtual) machine. In some embodiments, the interfaces between different RAT processes may be standardized such that different RATs can be coordinated with each other, which may involve interworking processes or which may involve supporting a subset of available commands for a RAT, in some embodiments.

Continuing, in some embodiments, a multi-RAT CU protocol stack at the all-G DU is configured as shown and enables a multi-RAT CU-CP and multi-RAT CU-UP, performing RRC, PDCP, and SDAP for all-G. As well, some portion of the base station (DU or CU) may be in the cloud or on COTS hardware (O-Cloud), as shown. Coordination with SMO and the all-G near-RT RIC and the all-G non-RT RIC may be performed using the A1 and O2 function interfaces, as shown and elsewhere as specified by the ORAN and 3GPP interfaces for 4G/5G.

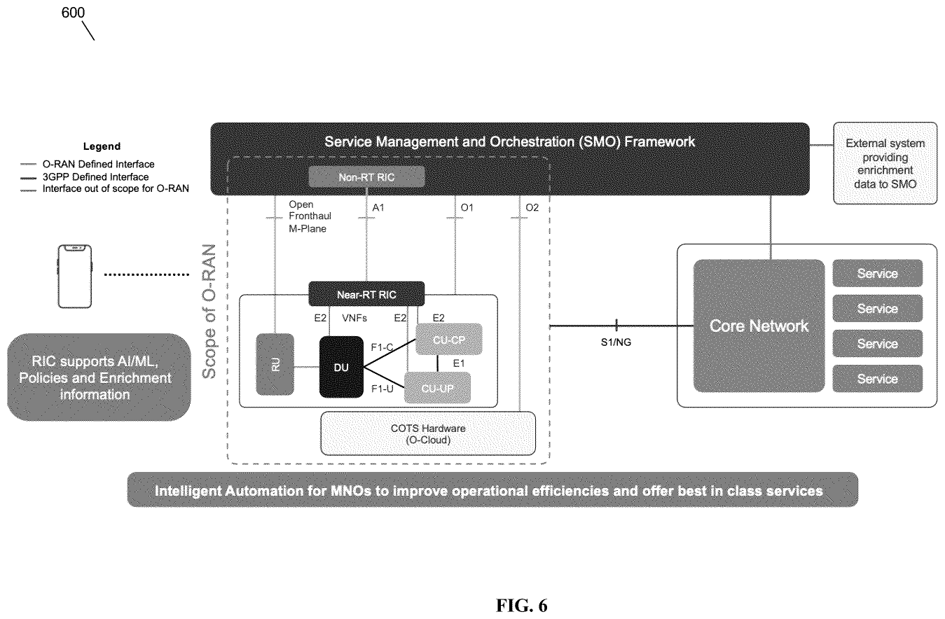

FIG. 6 is a further schematic diagram of a multi-RAT RAN deployment architecture, in accordance with some embodiments. This schematic diagram shows the use of the near/non-RT RIC to provide AI/ML (artificial intelligence and machine learning) policies and enrichment across Gs. This may also involve an SMO framework that is outside of the RAN, that is interfaced through the non-RT RIC, and may also involve an external system providing enrichment data to the SMO, as well as the core network and any services thereon, in some embodiments. The all-G Non-RT RIC serves as the integration point for performing network optimizations and adjustments that take into account any offline processes for AI/ML that involve adjustments that operate outside of the UE latency window (for 4G/5G˜100 ms), in some embodiments.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method of providing warnings in a telecom network based on forecasting a Key Performance Indicator (KPI), the method comprising:
receiving, at a data processing and preparation service, data;
transforming, by the data processing and preparation service, the data;
feeding the transformed data to a forecasting model;
predicting, by the forecasting model, a future KPI value for each cell, wherein the KPI has a pre-trained model for prediction that covers all cells;
sending, by the forecasting model, predictions to a notification component;
receiving, by the notification component, predicted KPI values; and
matching, by the notification component, the predicted KPI value against an individual KPI threshold specific to the KPI to generate warnings for a predicted KPI value that exceeds the individual KPI threshold.

2. The method of claim 1, further comprising training a plurality of forecasting models, one per KPI.

3. The method of claim 1, further comprising training the plurality of forecasting models at a non-real time radio access network intelligent controller (non-RT RIC) in an OpenRAN compatible deployment architecture.

4. The method of claim 1, further comprising performing the method for multiple KPIs.

5. The method of claim 1, further comprising training the plurality of forecasting models to be specific to individual cells.

6. The method of claim 1, further comprising training the plurality of forecasting models for individual cells at a near-real time radio access network intelligent controller (near-RT RIC).

7. The method of claim 1, wherein the KPIs are 4G or 5G networking metrics.

8. The method of claim 1, wherein the KPIs are 2G or 3G networking metrics.

9. The method of claim 1, wherein the plurality of forecasting models are one of convolutional neural networks (CNNs) or long short term memory networks (LSTMs).

10. The method of claim 1, wherein the at least one N-dimensional tensor is used for training N-dimensional models which can provide context for context-aware predictions.
